(19) United States
(12) Patent Application Publication
(10) Pub. No.: US 2014/0270686 A1
(43) Pub. Date: Sep. 18, 2014

(54) SYSTEM FOR WIRELESS VIDEO AND AUDIO CAPTURING

(71) Applicant: Teradek LLC, Irvine, CA (US)

(72) Inventor: Nicolaas Louis Verheem, Laguna Niguel, CA (US)

(73) Assignee: Teradek LLC, Irvine, CA (US)

(21) Appl. No.: 14/198,448

(22) Filed: Mar. 5, 2014

Related U.S. Application Data
(60) Provisional application No. 61/794,210, filed on Mar. 15, 2013.

(51) Int. Cl. H04N 5/77

(52) U.S. Cl. CPC H04N 5/77
USPC 386/224

(57) ABSTRACT

Certain embodiments disclosed herein provide systems and/or methods in which digital video data from a wireless audio/video receiver system is written directly into a computer's memory for storage or manipulation in order to save time delay, cost and size, instead of converting it back to a standard video format, only to be captured into memory by another device.

### RELATED APPLICATIONS INCORPORATION BY REFERENCE TO ANY PRIORITY APPLICATIONS

This application claims the benefit under 35 U.S.C. §119(e) of U.S. Provisional Application No. 61/794,210, entitled “SYSTEM FOR WIRELESS VIDEO AND AUDIO CAPTURING,” filed Mar. 15, 2013, the entire content of which is incorporated by reference herein in its entirety and made part of this specification.

### BACKGROUND

Multi camera live audio/video switching systems are used in all levels of video production, including live event webcasts (for example, talk shows), entertainment events (for example, live music performances), sports broadcasts, news shows, and the like.

### SUMMARY OF CERTAIN EMBODIMENTS

One embodiment discloses a method comprising writing digital video data from a wireless audio/video receiver system substantially directly into a computer's memory in order to save time delay, cost and size.

Another embodiment discloses a system comprising: a wireless audio/video receiver; and a computer comprising memory; wherein the system is configured to write digital video data from the receiver substantially directly into a computer's memory in order to save time delay, cost and size, without converting the data back to a standard video format and capturing the data into memory by another device.

### BRIEF DESCRIPTION OF THE DRAWINGS

FIG. 1 is a network diagram schematically illustrating an embodiment of a live video transmission system.

FIG. 2 is a network diagram schematically illustrating an embodiment of a live video transmission system for wireless video and audio capturing.

### DETAILED DESCRIPTION

Multi camera live audio/video switching systems are used in all levels of video production, including live event webcasts (for example, talk shows), entertainment events (for example, live music performances), sports broadcasts, news shows, and the like. Advances in computers processing power have made it possible to perform live video switching in software running on a desktop computer or even laptop (with the appropriate video capture cards). Such solutions may provide relatively lower cost and smaller size. Furthermore, the associated hardware is ubiquitous and can be used for other purposes too.

Separately, systems for sending video signals wirelessly are also used in the above-recited applications, which may serve to accommodate roving cameras, or transmissions from cameras positioned angles wherein the use of cables would be impractical or undesirable. Recent advances in the field of wireless video may make it possible to embed the electronics required into a smaller form factor, opening up new opportunities. Computers continue to gain processing power now making it possible to handle multiple uncompressed video streams simultaneously.

Many wireless video systems typically stay in the cable domain, that is, they are not designed to integrate in computer networks or computer memory. Certain wireless video systems may generally output video in a format that can be run over a cable to a monitor or a recorder. However, there is a need for a system that allows ingesting the video directly in to a computer where it can be manipulated or recorded, without the intermediate step of converting it to a standards based transport format, and converting it back to “raw” video in memory.

Certain embodiments disclosed herein provide systems and/or methods in which digital video data from a wireless audio/video receiver system is written directly into a computer's memory for storage or manipulation in order to save time delay, cost and size, instead of converting it back to a standard video format, only to be captured into memory by another device.

Certain embodiments disclosed herein provide a system that includes (1) wireless audio/video/metadata transmitter unit, that in one application can be mounted on the camera, or in proximity of the camera and/or built into the camera; and (2) a matched wireless audio/video/metadata receiver unit, integrated and powered from a desktop or laptop computer, capable of ingesting digital video data directly into the computer without the need for a separate capturing device.

By eliminating the process of converting the baseband “raw” digital audio/video/metadata signal back to a standard video signal like SDI or HDMI, then “capturing” the video into a computer's memory, the system may save cost, size and delay (latency) on the video signal path, which can provide a substantial benefit in live productions with multiple cameras, where some or all of the cameras must be synchronized.

The data may contain one or more of the following: audio, video, metadata (such as, for example, timestamp, lens data, and so forth). In one embodiment, the receiver (2) may be an expansion card form factor, allowing it to be plugged into a desktop computer. In another embodiment, the receiver (2) may be a self-contained device, powered over a serial communications bus, such as USB, Firewire, ThunderBolt, or the like. In another embodiment, the receiver (2) may be a self-contained box, which receives power from an external source.

In one embodiment, the receiver (2) may include one or more built-in antennas to receive the wireless signal. In another embodiment, the receiver (2) may include one or more external antenna connectors to allow antennas to be exchanged for higher-gain antennas, or remotely placed.

In one embodiment, the data sent from the transmitter (1) to the receiver (2) may be compressed data (for example, H.264, AVC, H.265, HEVC). In one embodiment, the data sent from the transmitter (1) to the receiver (2) could be uncompressed data (for example, OFDM, QAM, 4:2:2, 4:2:0). In one embodiment, the data sent from the transmitter (1) to the receiver (2) could be based on Internet Protocol. In one embodiment, the data sent from the transmitter (1) to the receiver (2) could include proprietary data. In one embodiment, the data sent from the transmitter (1) to the receiver (2) could be sent point-to-point (1:1). In one embodiment, the data sent from the transmitter (1) to the receiver (2) could be sent as a multicast transmission (such as, one-to-many). In one embodiment, the data sent from the receiver (2) could be frame-based audio/video/metadata, in another it could be pixel based, in yet another it could be isochronous (continuing) stream of data. In one embodiment the data may be converted back into a standard video format like HDMI or SDI to monitor or record on an external device.

### Additional Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the systems and methods. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

What is claimed is:

1. A method comprising:
writing digital video data from a wireless audio/video receiver system substantially directly into a computer's memory in order to save time delay, cost and size.

2. The method of claim 1, wherein the digital video data is not converted back to a standard video format and captured into memory by another device.

3. A system comprising:
a wireless audio/video receiver; and
a computer comprising memory;
wherein the system is configured to write digital video data from the receiver substantially directly into a computer's memory in order to save time delay, cost and size, without converting the data back to a standard video format and capturing the data into memory by another device.
